(19) United States
(12) Patent Application Publication
(10) Pub. No.: US 2015/0237453 A1
(43) Pub. Date: Aug. 20, 2015

(54) Method Of Manufacturing Assemblies For Hearing Aids

(71) Applicant: Sonion A/S, Roskilde (DK)

(72) Inventors: Robert Kaminski, Szczecin (PL); Piotr Dabrowski, Szczecin (PL); Malgorzata Paruszewska, Warzymice (PL); Jan Hijman, De Bilt (NL); Konrad Van Den Berg, Zoetermeer (NL)

(21) Appl. No.: 14/625,283

(22) Filed: Feb. 18, 2015

(30) Foreign Application Priority Data
Feb. 18, 2014 (EP) 14155538.3

(51) Int. Cl. H04R 31/00; H04R 25/00

(52) U.S. Cl. CPC H04R 31/00; H04R 25/60; H04R 2225/021

(57) ABSTRACT

The present invention provides a method of manufacturing a receiver-in-canal assembly. The method comprises the steps of providing a receiver housing configured to be positioned in or at the ear canal of a user, and further being configured to comprise a receiver configured to output sound; providing a connector housing configured to be connected to a behind-the-ear part of a hearing aid; and providing an elongated tube configured for transfer of a signal from the connector housing to the receiver housing. In a further step the receiver housing and the connector housing are attached to opposite ends of the elongated tube. Subsequently, the tube is permanently deformed after attachment of the receiver housing and the connector housing to the tube by exposing it to heat in a first predetermined treatment period.

### CROSS-REFERENCE TO RELATED APPLICATION

This application claims the benefit of European Patent Application Serial No. EP14155538.3, filed Feb. 18, 2014, and titled “A Method Of Manufacturing Assemblies For Hearing Aids,” which is incorporated herein by reference in its entirety.

### FIELD OF THE INVENTION

The present invention relates to an improved method of manufacturing receiver-in-canal assemblies for hearing aids. The receiver-in-canal assembly comprises a receiver housing configured to be positioned in or at the ear canal of a user, and further being configured to comprise a receiver configured to output sound. The assembly further comprises a connector housing configured to be connected to a behind-the-ear part of a hearing aid, and an elongated tube configured for transfer of a signal from the connector housing to the receiver housing.

### BACKGROUND OF THE INVENTION

Manufacturing of receiver-in-canal assemblies for hearing aids comprises a step of assembling a receiver housing and a connector housing with an elongated tube configured for transfer of a signal from the connector housing to the receiver housing. The receiver housing is configured to be positioned in or at the ear canal of a user, and is further configured to comprise a receiver which is configured to output sound. The connector housing is configured to be connected to a behind-the-ear part of a hearing aid.

To facilitate positioning of the receiver housing in or at the ear canal and to facilitate positioning of the connector housing on or behind the ear of a user, the elongated tube has to be bent, and in order to ensure that the hearing aid is kept in place it may be an advantage, that the tube is permanently bended, and thus permanently deformed. One way to achieve this is to heat the tube. As both the receiver housing and the connector housing may comprise heat sensitive components, permanent deformation of the elongated tube is traditionally carried out as one of the first steps in the manufacturing process. Subsequently, the receiver housing and the connector housing can be attached to opposite ends of the bended tube.

Assembling of hearing aids comprising a bended tube may result in a high reject rate, as process steps including gluing, soldering, and the like, are difficult and associated with a high error rate due to the very small size of the different elements. This is further hampered by fixtures required to keep the bended tube in a fixed position during assembly as these limit the freedom of handling. One of the problems is that the bended tube, despite the permanent deformation is re-straightened or at least un-bended to a certain degree. Furthermore, the receiver housing and/or the connector housing may be attached at an angle which differs from the required angle. Finally, the assembly process is time consuming.

### DESCRIPTION OF THE INVENTION

It is an object of embodiment of the invention to provide an improved method of manufacturing hearing aids.

It is a further object of embodiments of the invention to provide a method which reduces the time consumption associated with manufacturing of hearing aids.

It is an even further object of embodiments of the invention to provide a method which reduces the number of receiver-in-canal assemblies to be rejected during or after the manufacturing process.

According to a first aspect, the invention provides a method of manufacturing a receiver-in-canal assembly, the method comprising the steps of:
providing a receiver housing configured to be positioned in or at the ear canal of a user, and further being configured to comprise a receiver to output sound;
providing a connector housing configured to be connected to a behind-the-ear part of a hearing aid;
providing an elongated tube configured for transfer of a signal from the connector housing to the receiver housing;
attaching the receiver housing and the connector housing to opposite ends of the elongated tube; and
permanently deforming the tube after attachment of the receiver housing and the connector housing to the tube by exposing it to heat in a first predetermined treatment period t1.

The receiver housing and the connector housing are attached to the tube prior to the deformation. In this un-bended state of the tube, positioning of the receiver housing relative to the connector housing may be performed very precise.

Since the tube is deformed after attachment of the receiver housing and the connector housing, the deformation process is based on a final relative orientation of the tube, the receiver housing, and the connector housing. Accordingly, a more precise tube shape relative to the orientation of the receiver housing and connector housing can be obtained.

The receiver housing may comprise a front housing part and a rear housing part. In one embodiment, the receiver may be positioned in the rear housing part. The connector housing may comprise a plug part configured for attachment to the elongated tube and a plug base configured for attachment to a behind-the-ear part of a hearing aid.

In the context of the present invention, an “elongated tube” should be understood as a hollow tube having a length being considerably longer than the diameter of the tube, such as a length being at least 5 times larger than the largest dimension of the tube in a direction perpendicular to the longitudinal axis. The length of the tube may be in the range of 30-80 mm. The diameter of the tube may be in the range of 0.5-2 mm. The tube may be made from a plastic material, such as a polymer. In one embodiment, the provided elongated tube is straight.

The receiver may be adapted to receive an electrical signal and output a corresponding audio signal. As the signal to be transferred via the tube may be sound and/or an electric signal and/or an optical signal, the elongated tube may comprise at least one wire. The step of permanently deforming the tube may thus include bending of the at least one wire. The at least one wire may be attached to the inner wall of the tube to ensure that the wire is kept in place both during the manufacturing process and during use of the hearing air. Alternatively, the at least one wire may be moulded into the wall of the tube.

The behind-the-ear part may comprise electronics, controls, battery, microphone(s), and a receiver, if the receiver is not positioned in the receiver housing. However, an additional receiver may be positioned in the behind-the-ear part, if a receiver is positioned in the receiver housing. As an example, the additional receiver may be a bass receiver.

The behind-the-ear part and the connector housing may be provided with corresponding attachment elements to enable connection of the connector housing to the behind-the-ear part. As an example, these attachment elements may comprise plugs, corresponding inner and outer threading, snap-fit, or other similar attachment means allowing subsequently release of the behind-the-ear part. To enable electrical contact between the two elements, the connector housing may comprise connecting members, e.g. on the outside of the plug base, configured for contact with corresponding connecting members at the behind-the-ear part.

As an alternative, the behind-the-ear part and the connector may be permanently connected to each other after deformation of the tube. This may be achieved by gluing, welding, soldering, or other similar processes.

By positioning the electrical components outside the ear, the risk of moisture and earwax damaging the components can be considerably reduced, which may increase the durability of the hearing air.

The receiver housing may be made of a soft material, such as silicone, to improve comfort for the user. Alternatively, the receiver housing may be located in a shell made of a soft material, thereby improving the comfort. The receiver housing may be inserted in the shell after permanent deformation of the tube to ensure that the shell is not affected by the heating of the tube.

To improve comfort further, an individual shell may be made for each user to fit the ear of the user. Furthermore, the shell may be provided with a dome to improve comfort. Additionally, the behind-the-ear part may be arc-shaped to facilitate positioning of the hearing aid and the improve comfort.

The receiver housing and the connector housing may be attached to opposite ends of the elongated tube by different processes, such as gluing, welding, soldering, heat shrinking, etc. It should be understood, that the receiver housing may be attached by use of one process, whereas the connector housing may be attached using another process.

Traditionally, the tube has been heated by convection of hot air, e.g. by positioning the tube in an oven. To decrease time consumption associated with deformation of the tube, the step of permanently deforming the tube by exposing it to heat may be carried out by heat conduction.

In one embodiment, the step of exposing the tube to heat comprises a step of establishing contact between the tube and a heating surface to facilitate permanently deformation of the tube. The process temperature T1, i.e. the temperature to which the tube is heated, may vary, e.g. in dependency of the tube material, the tube material thickness, the size of the tube, etc.

To improve precision of the shape of the deformed tube, the step of establishing contact between the tube and the heating surface may comprise a step of arranging the tube in a fixture comprising the heating surface. The fixture may be configured to fix the tube in a deformed configuration which corresponds to the required shape of the tube of the receiver-in canal assembly.

The fixture may comprise a plate, e.g. made of metal, such as an alloy. The plate may be provided with a depression having a shape corresponding to the required shape of the tube in its final configuration. As an example, the elongated tube may manually be arranged in the depression by bending is by hand. When arranged in the depression, the fixture may fix the tube, and subsequently the permanent deformation may be carried out by exposing the tube to heat.

It should be understood that the arrangement of the tube in the fixture may alternatively be done automatically, e.g. by a robot, or a similar automatic process.

As the step of permanently deforming the tube may simultaneously be carried out for a plurality of receiver-in-canal assemblies, the fixture may be configured to fix a plurality of tubes, such as 2, 5, 7, 10, or even more tubes thereby facilitating simultaneous manufacturing of a number of receiver-in-canal assemblies. It should be understood, that a number of different fixtures may be applicable in order to provide assemblies of different size and/or shape e.g. depending on the user being a child or an adult. Consequently, the tubes may be deformed differently to fit different users.

The tube is permanently deformed after attachment of the receiver housing and the connector housing by exposing it to heat in a first predetermined treatment period t1. Due to the use of heat conduction, this first predetermined period of time t1 may be considerably smaller than the traditional heating period. In one embodiment, the first predetermined treatment period t1 is less than 6 minutes, such as less than 5 minutes.

To improve the deformation process of the tube, the step of permanently deforming the tube may comprise an additional step of cooling it for a second predetermined treatment period t2 after exposing it to heat. The second treatment period t2 may be less than 50 percent of the first treatment period t1. By cooling the deformed tube, the permanent deformation of the tube may be achieve more efficiently, thereby decreasing the time consumption associated with the deformation.

To facilitate cooling of the tube, the step of cooling the tube may comprise a step of establishing contact between the tube and a cooling surface as this may decrease the manufacturing time even further.

The step of establishing contact between the tube and the cooling surface may comprises a step of arranging the tube in a fixture comprising the cooling surface. The fixture may be configured to fix the tube in a deformed configuration.

It should be understood, that the fixture comprising the cooling surface may be the same fixture comprising the heating surface. Thus, the tube may initially be arranged in a deformation fixture which may comprise both a cooling surface and a heating surface, so that the permanently deformed tube is fixed in the fixture both during the first predetermined treatment period t1 and the second predetermined treatment period t2. This deformation fixture may be arranged in at least two different positions, a first position where contact is established between the tube and a heating surface and a second position where contact is established between the tube and a cooling surface.

This fixture may likewise be configured to fix a plurality of tubes, such as 2, 5, 7, 10, or even more tubes.

As an alternative, the fixture may be a separate element which may be arranged at two different locations, a first location where contact is established between the tube and a heating surface and a second location where contact is established between the tube and a cooling surface.

In a further alternative, the heating surface and the cooling surface may be one single element which may be configured to heat in a first configuration and may be configured to cool in a second configuration.

Due to the established contact between the tube and the cooling surface, the second predetermined treatment period t2 may be less than 3 minutes, such as less than 2 minutes.

The method may further comprise an intermediate treatment period tx between the first and second treatment period. The intermediate treatment period tx may be less than 10 percent of the first treatment period. During the intermediate treatment period tx, the at least one tube may be moved from the exposure to heat to the exposure to cold, or the heating/cooling surface may change from hot to cool.

In order to protect the receiver housing and the connector housing during the permanent deformation of the tube, the method may comprises a step of providing a thermal shield, and a step of arranging the thermal shield so that at least one of the receiver housing and the connector housing is not exposed to heat.

Shielding may alternative be provided by arranging at least one of the receiver housing and the connector housing so that it is not exposed to heat, e.g. by bending the tube in the area of the receiver housing so that contact between the receiver housing and the heating surface can be avoided.

According to a second aspect, the invention provides a receiver-in-canal assembly manufactured by the method according to the first aspect of the invention. It should be understood, that a skilled person would readily recognise that any feature described in combination with the first aspect of the invention could also be combined with the second aspect of the invention, and vice versa.

The method according to the first aspect of the invention is very suitable for manufacturing the assembly according to the second aspect of the invention. The remarks set forth above in relation to the method are therefore equally applicable in relation to the assembly.

### BRIEF DESCRIPTION OF THE DRAWINGS

Embodiments of the invention will now be further described with reference to the drawings, in which:

FIG. 1 schematically illustrates an un-assembled receiver-in-canal assembly comprising a receiver housing, a connector housing, and an elongated tube.

FIG. 2 schematically illustrates an assembled receiver-in-canal assembly before permanent deformation of the elongated tube,

FIG. 3 illustrates a receiver-in-canal assembly after permanent deformation of the elongated tube,

FIG. 4 illustrates a curve for the treatment temperature T in dependency of time t,

FIG. 5 illustrates a fixture configured to fix the tube in a deformed configuration, and

FIG. 6 illustrates a fixture applied in a step of establishing contact between the tube and a heating surface.

### DETAILED DESCRIPTION OF THE DRAWINGS

It should be understood that the detailed description and specific examples, while indicating embodiments of the invention, are given by way of illustration only, since various changes and modifications within the spirit and scope of the invention will become apparent to those skilled in the art from this detailed description.

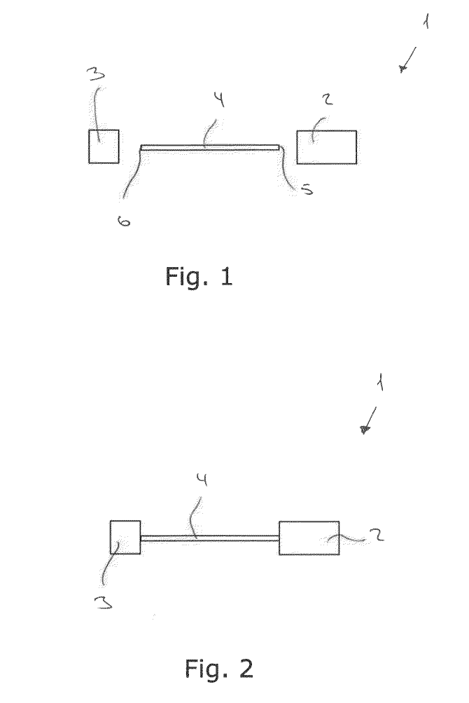

FIG. 1 schematically illustrates an un-assembled receiver-in-canal assembly 1 which comprises a receiver housing 2, a connector housing 3, and an elongated tube 4. The receiver housing 2 and the connector housing 3 are configured to be attached to opposite ends 5, 6 of the elongated tube 4.

FIGS. 1 and 2 are for illustration of the different features only, and it should be understood that the features are not correctly scaled relative to each other.

The receiver housing 2 is configured to be positioned in or at the ear canal of a user, and is further configured to comprise a receiver (not shown), which receiver is configured to output sound. The connector housing 3 is configured to be connected to a behind-the-ear part (not shown) of a hearing aid. The behind-the-ear part is configured to generate the sound signal which may be transferred to the receiver housing 2 and the receiver via the elongated tube 4.

FIG. 2 schematically illustrates a receiver-in-canal assembly 1 where the receiver housing 2 and the connector housing 3 have been attached to opposite ends 5, 6 of the elongated tube 4.

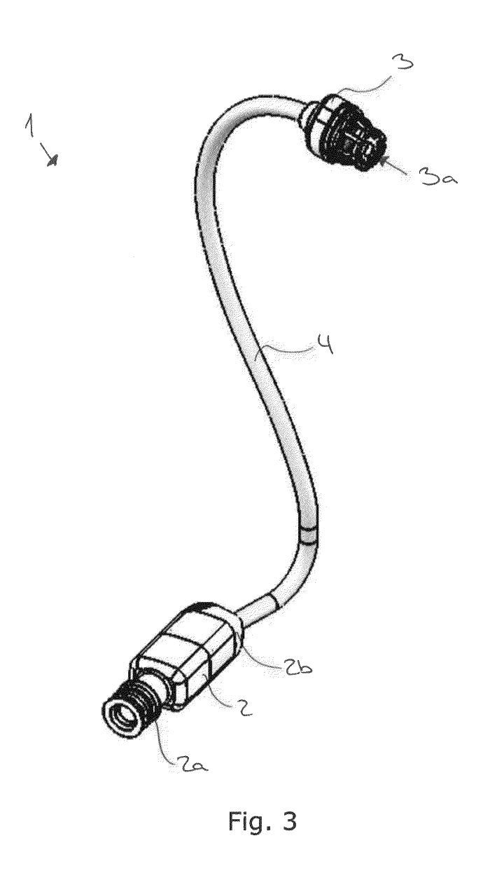

FIG. 3 illustrates the receiver-in-canal assembly 1 after permanent deformation of the elongated tube 4. The receiver housing 2 comprises a front housing part 2a and a rear housing part 2b. In the illustrated embodiment, the receiver (not shown) is positioned in the rear housing part 2b.

The connector housing 3 is configured to be connected to a behind-the-ear part (nor shown) of a hearing aid via the plug base 3a.

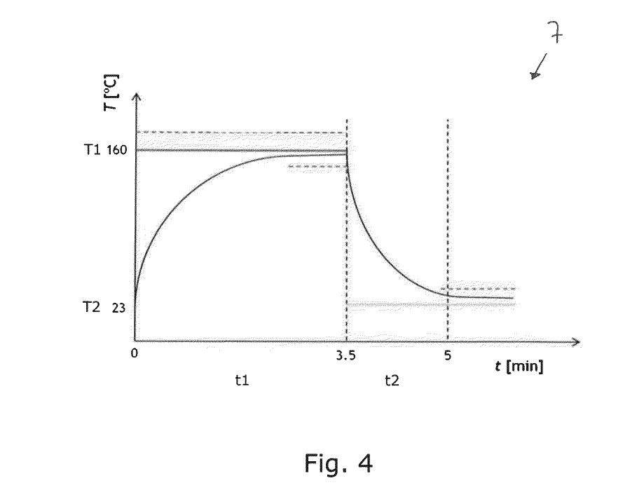

FIG. 4 illustrates a curve 7 for the treatment temperature T [degrees Celsius] in dependency of time t [minutes]. In the illustrated embodiment, the elongated tube 4 is heated to a process temperature T1 of 160 degrees Celsius+/−2 degrees Celsius during a first treatment period t1 till this temperature is reached. The first treatment period t1 is in this embodiment 3.5 minutes. The maximum temperature, being the process temperature T1 is maintained during an additional treatment period of 30 seconds. The additional treatment period starts from the moment when the first treatment period t1 is completed. The additional treatment period does not appear from FIG. 4.

The additional treatment period depends on the material properties of the tubes 4 and more specifically on the relaxation properties. Relaxation should be understood as the process of a material, such as polymers, undergoing a change of internal structure under constant stress. The additional treatment period may be less than 1 minutes, such as about 30 seconds.

Subsequently, the elongated tube 4 is cooled down to about room temperature T2 during a second treatment period t2. In the illustrated embodiment the second treatment period t2 is 1.5 minutes. This second treatment period t2 may however be shorter, such as approximately 1 minute, or even shorter, such as about 30 seconds.

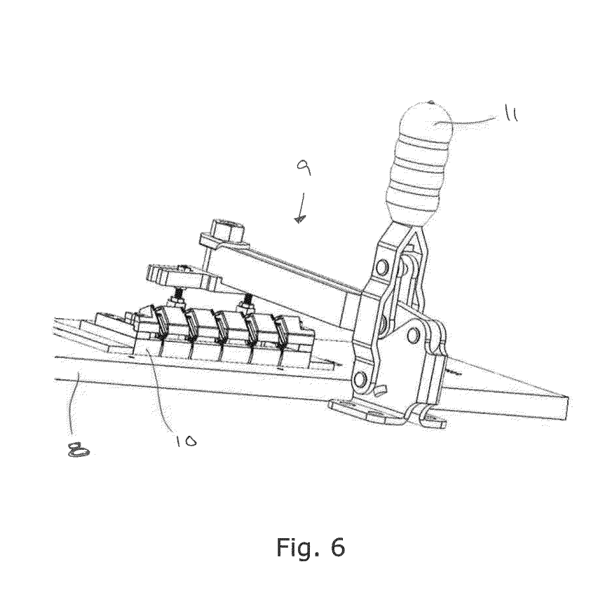

Heating during the first treatment period t1 is carried out by positioning the elongated tube 4 on a heating surface 8 (see FIG. 6) so that it can be heated by conduction. The subsequent cooling of the tube 4 during the second treatment period t2 is carried out by positioning the tube on a cooling surface (not shown) during the second treatment period t2.

The cooling of the tube 4 need not reach room temperature T2 by aid of the cooling surface, as the final cooling may take place after interruption of contact between the tube(s) and the cooling surface. Consequently, the tube(s) may be cooled to a temperature in the range of e.g. 20-40 degrees Celsius by aid of the cooling surface.

The deformation process for the elongated tube further comprises a step of moving the tube from the heating surface to the cooling surface. This intermediate step is performed during an intermediate treatment period tx between the first and second treatment periods t1, t2. Typically, this intermediate treatment period tx has a duration of approximately less than 30 seconds.

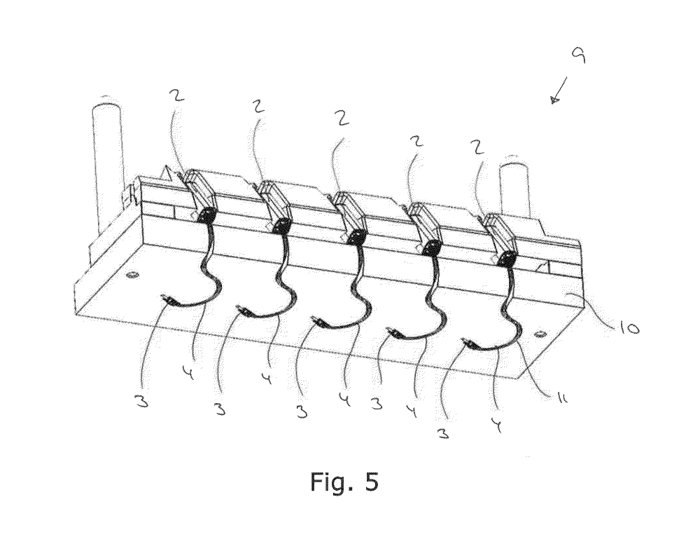

FIG. 5 illustrates a fixture 9 configured to fix five tubes 4 in a deformed configuration after attachment of the receiver housing 2 and the connector housing 3. The fixture 9 comprises a plate 10 made of an alloy. The plate 10 is provided with five depressions 11 each having a shape corresponding to the required shape of the tubes 4 in their final configuration. When arranged in the depressions 11, the fixture 9 fixes the tubes 4. Subsequently the permanent deformation can be achieved by exposing the tubes 4 to heat.

FIG. 6 illustrates the tubes (not visible) being exposed to heat by establishing contact between the tubes and the heating surface 8. The tubes 4 are placed in a deformed configuration in the fixture 9, and subsequently the fixture 9 is placed on the heating surface 8 which heats. The fixture 9 is operated by use of the handle 11. When the handle 11 is moved, the plate 10 with the tubes 4 can be moved up and down to establish and interrupt contact between the tubes 4 and the heating surface 8.

Due to temperature gradients present in the plate 10 and to ensure that the deformed tubes 4 present in the fixture 9 reaches the desired temperature, the plate 10 is maintained on the heating surface 8 for an additional treatment period.

1. A method of manufacturing a receiver-in-canal assembly, the method comprising the steps of:
providing a receiver housing configured to be positioned in or at the ear canal of a user, and further being configured to comprise a receiver to output sound;
providing a connector housing configured to be connected to a behind-the-ear part of a hearing aid;
providing an elongated tube configured for transfer of a signal from the connector housing to the receiver housing;
attaching the receiver housing and the connector housing to opposite ends of the elongated tube; and
permanently deforming the tube after attachment of the receiver housing and the connector housing to the tube by exposing it to heat in a first predetermined treatment period t1.

2. A method according to claim 1, wherein the provided elongated tube is straight.

3. A method according to claim 1, wherein the elongated tube comprises at least one wire, and wherein the step of permanently deforming the tube comprises bending of the at least one wire.

4. A method according to claim 1, wherein the step of permanently deforming the tube by exposing it to heat is carried out by heat conduction.

5. A method according to claim 4, wherein the step of exposing the tube to heat comprises a step of establishing contact between the tube and a heating surface.

6. A method according to claim 5, wherein the step of establishing contact comprises a step of arranging the tube in a fixture comprising the heating surface, the fixture being configured to fix the tube in a deformed configuration.

7. A method according to claim 1, wherein the first predetermined treatment t1 period is less than 6 minutes.

8. A method according to claim 1, wherein the step of permanently deforming the tube comprises a step of cooling it for a second predetermined treatment period t2 after exposing it to heat, the second treatment period t2 being less than 50 percent of the first treatment period t1.

9. A method according to claim 8, wherein the step of cooling the tube comprises a step of establishing contact between the tube and a cooling surface.

10. A method according to claim 9, wherein the step of establishing contact comprises a step of arranging the tube in a fixture comprising the cooling surface, the fixture being configured to fix the tube in a deformed configuration.

11. A method according to claim 8, wherein the second predetermined treatment period t2 is less than 3 minutes.

12. A method according to claim 8, further comprising an intermediate treatment period tx between the first and second treatment period t1, t2, the intermediate treatment period tx being less than 10 percent of the first treatment period t1.

13. A method according to claim 1, further comprising a step of providing a thermal shield, and a step of arranging the thermal shield so that at least one of the receiver housing and the connector housing is not exposed to heat.

14. A method according to claim 1, wherein the step of permanently deforming the tube is simultaneously carried out for a plurality of receiver-in-canal assemblies.

15. A method according to claim 2, wherein the elongated tube comprises at least one wire, and wherein the step of permanently deforming the tube comprises bending of the at least one wire.

16. A method according to claim 2, wherein the step of permanently deforming the tube comprises a step of cooling it for a second predetermined treatment period t2 after exposing it to heat, the second treatment period t2 being less than 50 percent of the first treatment period t1.

17. A method according to claim 3, wherein the step of permanently deforming the tube comprises a step of cooling it for a second predetermined treatment period t2 after exposing it to heat, the second treatment period t2 being less than 50 percent of the first treatment period t1.

18. A method according to claim 9, further comprising an intermediate treatment period tx between the first and second treatment period t1, t2, the intermediate treatment period tx being less than 10 percent of the first treatment period t1.

19. A method according to claim 2, further comprising a step of providing a thermal shield, and a step of arranging the thermal shield so that at least one of the receiver housing and the connector housing is not exposed to heat.

20. A method according to claim 2, wherein the step of permanently deforming the tube is simultaneously carried out for a plurality of receiver-in-canal assemblies.
